(19) United States
(12) Patent Application Publication
(10) Pub. No.: US 2019/0085925 A1
(43) Pub. Date: Mar. 21, 2019

(54) ELECTROMAGNETIC CLUTCH OR BRAKE

(71) Applicant: JIAXING LUPAI BRAKE CO., LTD., Jiaxing (CN)

(72) Inventor: JIAN LU, JIAXING (CN)

(73) Assignee: JIAXING LUPAI BRAKE CO., LTD.

(21) Appl. No.: 15/897,825

(22) Filed: Feb. 15, 2018

(30) Foreign Application Priority Data
Sep. 19, 2017 (CN) 201721206323.1

(51) Int. Cl. F16D 67/06; F16D 27/112

(52) U.S. Cl. CPC F16D 67/06; F16D 2121/20; F16D 27/112

(57) ABSTRACT

An improved electromagnetic clutch for use in a riding lawnmower or similar vehicle is provided. The clutch comprises a coil assembly, a rotor assembly and a pulley assembly. The coil assembly comprises a shell, an encapsulated coil and a coil ring, the coil ring is pressed in the encapsulated coil, the encapsulated coil is inside of the shell, the extended piece of the shell has magnets and brake pieces. The rotor assembly comprises a rotor and a shaft, the shaft pressed in the rotor and is on the coil ring. The pulley assembly comprises a pulley, an armature and leaf springs, one side of the leaf spring is pressed on armature and the another side is pressed on pulley, the pulley is on the shaft, the location of the armature is between brake pieces and rotor. The encapsulated coil has thermal fuse inside and the thermal fuse electrical connected with coil wires, the electricity will be cut off when the temperature of encapsulated coil higher than the melting point of the thermal fuse caused by fitting incorrect or slipping happened during clutch working to protect lawnmower parts or avoid fire accident.

### FIELD OF THE INVENTION

The present invention relates to weeder brake field, and more particularly, to an electromagnetic clutch for use in a riding lawn mower.

### BACKGROUND OF THE INVENTION

Clutches or brakes are devices used to make lawn mowers drive mowing cutters. Presently, the clutches used in riding lawnmowers lack in technology. The braking speed is slow and has poor stability. In the case of abnormal use or failure, the brakes are likely to overheat and cause spontaneous combustion. There are potential safety problems.

### SUMMARY OF THE INVENTION

The present invention provides an electromagnetic clutch.

An object of the present invention is to solve the backward technology of the clutches in the current market, wherein the braking speed is slow and has poor stability. In the case of abnormal use or failure, the brakes are likely to overheat and cause spontaneous combustion. There are potential safety problems.

The technical solution of the present invention to solve the technical problems is as follows: An electromagnetic clutch in accordance with the present invention comprises a coil assembly, a rotor assembly, and a pulley assembly. The coil assembly comprises a shell, a plastic encapsulated coil and a coil ring, the coil ring is pressed in the encapsulated coil, the encapsulated coil is inside of the shell, the extended piece of the shell has magnets and brake pieces. The rotor assembly comprises a rotor and a shaft, the shaft pressed in the rotor is on the coil ring. The pulley assembly comprises a pulley, an armature and leaf springs, one side of the leaf spring is pressed on the armature and the another side is pressed on pulley, the pulley is on the shaft, the armature is between brake pieces and rotor. The clutch has thermal fuse. In accordance with the present invention, the encapsulated coil has thermal fuse inside and the thermal fuse is electrical connected with coil wires.

Preferably, the side of the rotor facing armature has a friction ring.

Preferably, the shaft has a front part, a middle part and a back part, the pulley is in the front part, the rotor is in the middle part and the coil ring is in the back part.

Preferably, the spacer has concave groove, hollowed shaft has projecting key inside, the pulley is fixed on the shaft by spacer. Preferably, it further comprises a grooved fixing member, a through hole is arranged in the center of the shaft, a convex groove is arranged on an inner wall of the through hole, a groove is arranged on the grooved fixing member, the groove is communicated with the shaft through hole. The convex grooves on the inner wall are matched. The pulley is fixedly mounted on the shaft.

Preferably, the magnets are fixed by fixing sleeve, rivets through the brake pieces and fixing sleeves to fix the brake pieces and magnets on the extended outside of the shell.

The present invention has the effect of greatly cut off the electricity to protect lawnmower parts or avoid fire accident when the temperature of encapsulated coil is higher than the melting point of the thermal fuse which inside of the encapsulated coil caused by fitting incorrect or slipping happened during clutch working. The invention also has the surface of the rotor facing armature with a friction ring to make the armature catch up with rotor to get strong initial torque making the pulley start running well.

### BRIEF DESCRIPTION OF THE DRAWINGS

FIG. 1 is an explosive view of an electromagnetic clutch accordance with the present invention.

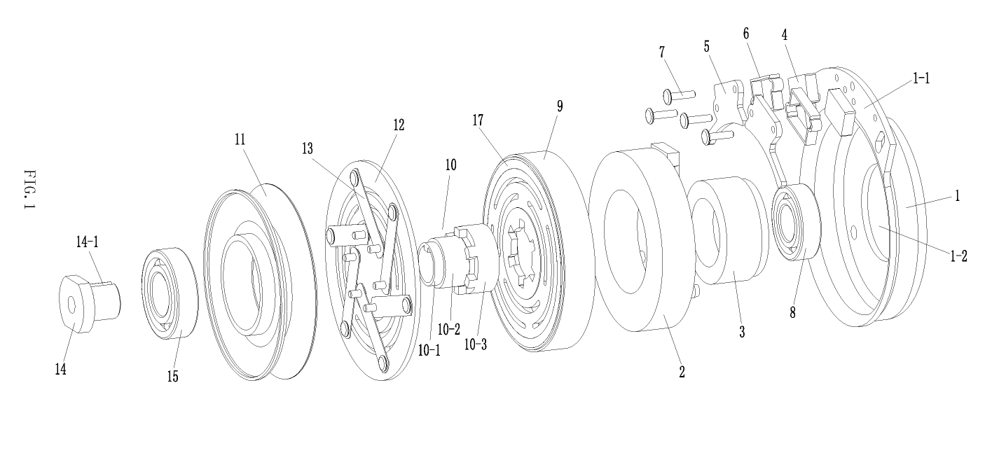

FIG. 2 is a cross-sectional view of the electromagnetic clutch.

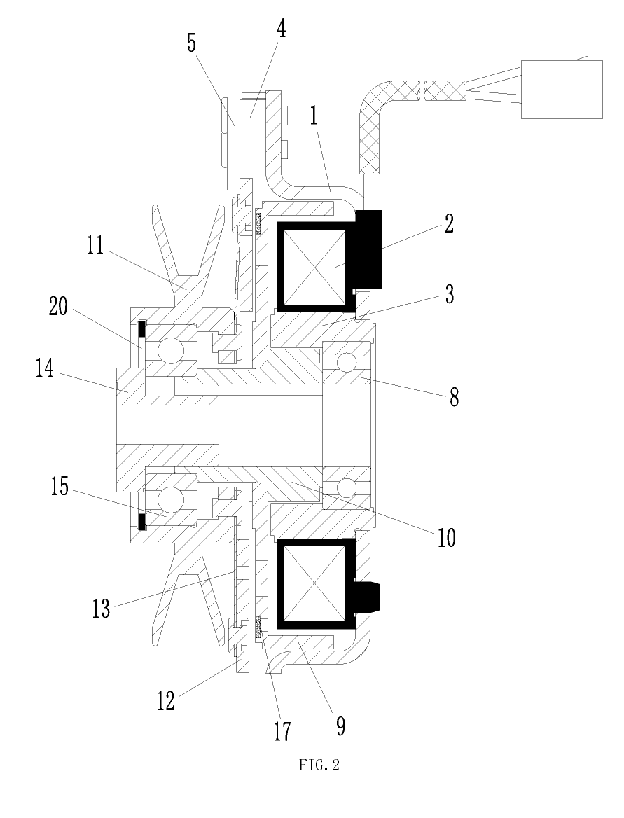

FIG. 3 is a structural representation of the thermal fuse inside of the encapsulated coil.

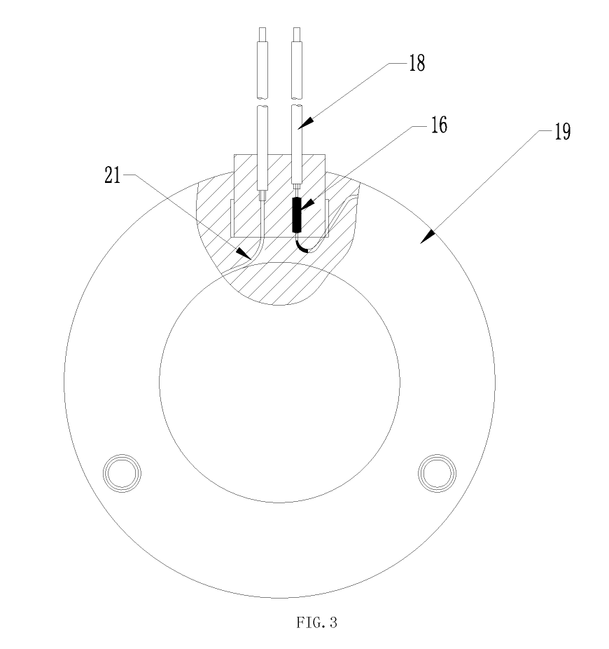

### DETAILED DESCRIPTION OF THE PREFERRED EMBODIMENTS

Referring now to the drawings wherein like reference numerals are used to identical components, the present invention comprises a coil assembly, a rotor assembly and a pulley assembly.

In accordance with the present invention, the coil assembly comprises a shell 1, a plastic encapsulated coil 2 and a coil ring 3, the coil ring 3 is pressed in the encapsulated coil 2, the encapsulated coil 2 is inside of the shell 1, the encapsulated coil 2 and coil ring 3 are all circular ring structure. The shell 1 is dish structure, the middle of the shell 1 has a centre hole 1-2, the outside of the shell 1 has extended piece 1-1 with magnets 4 and brake pieces 5, the magnets fixed by a fixing sleeve 6, brake pieces 6, rivets 7 through the brake pieces 5 and fixing sleeves 6 to fix the brake pieces 5 and magnets 4 on the extended piece 1-1 outside of the shell 1. There are two pieces of magnets 4 and two pieces of brake pieces 5. The encapsulated coil 2 has a thermal fuse 16, both sides of the thermal fuse 16 electrically connected with a coil wire 21, a guide line 18 is electrically connected with the coil wire 21 inside of the encapsulated coil 2. The thermal fuse 16 and coil wire 21 are totally covered by nylon 19.

In accordance with the present invention, the rotor assembly comprises a rotor 9 and a shaft 10. The surface of the rotor 9 facing an armature 12 is the frictional area which has a friction ring 17 inside and catches up with the armature 12 when the clutch is connected to electricity. The shaft 10 has a front part 10-1, a middle part 10-2 and a back part 10-3, the rotor 9 is in the middle part 10-2 and the coil ring 3 is in the back part 10-3.

In accordance with the present invention, the pulley assembly comprises a pulley 11, an armature 12 and a leaf spring 13. One side of the leaf spring 13 is pressed on the armature 12 and the other side of the leaf spring 13 is pressed on the pulley 11. The pulley 11 is in the shaft front part 10-1. The armature 12 is between brake pieces 5 and the rotor 9.

In accordance with the present invention, the coil ring 3 has a bearing 8, the pulley 11 has another bearing 15, the bearing 8 and the bearing 15 are located at the two sides of the shaft 10, the bearing 15 is pressed in an inner hole of the pulley 11 fixed by a snap ring 20, the snap ring 20 is also in an inner hole of the pulley 11, the snap ring 20 makes the bearing 15 be replaced easily. The spacer 14 with a concave groove 14-1 fixed the pulley 11 on the shaft 10 which has a projecting key inside.

The working principle is as follows: the engine shaft fixed into the shaft 10 makes the rotor 9 running all the time when the engine is working. The encapsulated coil 2 brings magnetic force when the clutch is powered by electricity, the armature 12 catches up with the rotor 9 by the magnetic force from the encapsulated coil 2 and leaves the brake pieces 5 at the same time. The surface of the rotor 9 with a friction ring 17 can enlarge the friction when the armature 12 catches up with the rotor 9 to make the armature 12 and the pulley 11 starting run well. The pulley 11 drives the lawnmower blade by a belt. When the clutch powered off, the armature 12 leaves the rotor 9 and returns to the position against to brake pieces 5 by the force of leaf springs 13. The brake pieces 5 has magnetic force as it is connected with magnets 4, the armature 12 catches up with the brake pieces 5 strongly to make the armature 12 and pulley 11 stop running. The thermal fuse 16 is electrically connected with encapsulated coil 2 to make the electricity be cut off when the temperature of the encapsulated coil 2 is higher than the melting point of the thermal fuse 16 caused by fitting incorrect or slipping happened during clutch working to protect lawnmower parts or avoid fire accident.

1. An electromagnetic clutch comprises a coil assembly, a rotor assembly and a pulley assembly; wherein the coil assembly comprises a shell, an encapsulated coil and a coil ring, the coil ring is pressed in the encapsulated coil, the encapsulated coil is inside of the shell, the extended piece of the shell has magnets and brake pieces; the rotor assembly comprises a rotor and a shaft, the shaft pressed in the rotor is on the coil ring; the pulley assembly comprises a pulley, an armature and leaf springs, one side of the leaf spring is pressed on the armature and the another side is pressed on the pulley, the pulley is on the shaft, the armature is between the brake pieces and the rotor; the clutch has thermal fuse; the encapsulated coil has thermal fuse inside and the thermal fuse is electrically connected with coil wires.

2. The electromagnetic clutch of claim 1 wherein the surface of rotor facing armature has a friction ring.

3. The electromagnetic clutch of claim 1 wherein the shaft has a front part, a middle part and a back part, the pulley is in the front part, the rotor is in the middle part and the coil ring is in the back part.

4. The electromagnetic clutch of claim 1 wherein the clutch further comprises a grooved fixing member, a through hole is arranged in the center of the shaft, a convex groove is arranged on an inner wall of the through hole, a groove is arranged on the grooved fixing member, the groove is communicated with the shaft through hole, the convex grooves on the inner wall are matched, the pulley is fixedly mounted on the shaft.

5. The electromagnetic clutch of claim 1 wherein the magnets are fixed by fixing sleeves, the rivets through the brake pieces, fixing sleeves to fix the brake pieces and magnets on the extended outside of the shell.
